(19) United States
(12) Patent Application Publication
(10) Pub. No.: US 2015/0075665 A1
(43) Pub. Date: Mar. 19, 2015

(54) REFRIGERANT HOSE WITH METAL FOIL LAYER

(71) Applicant: Brian Henry, Sun Prairie, WI (US)

(72) Inventor: Brian Henry, Sun Prairie, WI (US)

(73) Assignee: VEYANCE TECHNOLOGIES, INC., Fairlawn, OH (US)

(21) Appl. No.: 14/487,595

(22) Filed: Sep. 16, 2014

Related U.S. Application Data
(60) Provisional application No. 61/878,932, filed on Sep. 17, 2013.

(51) Int. Cl. F16L 11/04; F16L 11/12

(52) U.S. Cl. CPC F16L 11/045; F16L 11/12; F16L 2011/047
USPC 138/127; 138/138

(57) ABSTRACT

The air conditioning hose of this invention offers an extremely high level of resistance to permeation by refrigerants, including carbon dioxide, as well as good flexibility, high strength, the ability to bend to small radii without kinking, and the ability to be tightly coupled to refrigeration device components in a leak proof fashion. The subject invention specifically discloses a refrigerant hose comprising: (a) a core layer, wherein the core layer is comprised of a thermoplastic polymer, and wherein the core layer includes perforations; (b) a metal foil layer which is situated over the core layer; (c) plastic layer which is situated over the metal foil layer; (d) a rubber layer which is situated over the plastic layer, (e) a reinforcing layer which is situated over the rubber layer; and (f) a cover layer which is situated over the reinforcing layer, wherein the cover layer is comprised of a rubbery polymer.

This application claims the benefit of U.S. Provisional Patent Application Ser. No. 61/878,932, filed on Sep. 17, 2013. The teachings of U.S. Provisional Patent Application Ser. No. 61/878,932 are incorporated herein by reference in their entirety.

### FIELD OF THE INVENTION

The present invention is directed to a hose suitable for use in the conveyance of refrigerants which are under high pressure for use in vehicle, industrial, and residential refrigerant systems, such as automotive air conditioning systems. This hose is of particular value in air conditioning systems that utilize carbon dioxide as the refrigerant. The refrigerant hose of this invention provides good flexibility coupled with a high level of resistance to permeation by refrigerants by virtue of including a layer of a metal foil, such as aluminum foil.

### BACKGROUND OF THE INVENTION

Hoses are used for transporting refrigerants in vehicle air conditioning systems, and in industrial and residential refrigerant systems and serve the purpose of joining the principal operating components of the refrigerating device. These hoses should have good flexibility, high strength, the ability to bend to small radii without kinking, small outside diameter in relation to inside diameter and impermeability to the fluids involved. Refrigeration hoses are subjected to temperature extremes in under-the-hood applications and accordingly must be capable of providing a long service life in an environment under which they are repeatedly subjected to both high and low temperatures. The normal operating temperatures encountered by air conditioning hose assemblies employed in automotive air conditioning applications generally range from about −30° C. to about 120° C. Typical design specifications call for such refrigerant hose to be capable of withstanding operation temperatures which are within the range of about −40° C. to 150° C. The higher temperatures are due mainly to the location of the system proximate to the engine as well as from the heat generated in compressing the refrigerant as a gas. Additionally, such hoses must be capable of being tightly attached to refrigeration device components in a leak proof fashion (meeting requirements for proper coupling attachment).

There is currently a desire to utilize carbon dioxide as the refrigerant for air conditioning systems. This is because carbon dioxide is an extremely environmental friendly alternative to the refrigerants currently being used in air conditioning systems today. However, conventional hoses do not offer the level of resistance to permeation of carbon dioxide which is needed in a commercially viable product. There is accordingly a need for an air conditioning hose which offers a high level of resistance to permeation by carbon dioxide and which also offers good flexibility, the high strength, the ability to bend to small radii without kinking, and which is capable of being tightly attached to refrigeration device components in a leak proof fashion.

Conventional refrigerant hoses, such as automotive air conditioner hoses, generally have a three-layer laminar construction consisting of an innermost layer, a reinforcing layer, and an outermost cover layer. The innermost tubular layer of such hose is typically formed of an elastomeric material intended to keep the refrigerant fluid and compressor lubricant in the hose while keeping moisture and air out. A layer of reinforcing braiding is wound upon the outside surface of the inner tube. The reinforcing fiber layer usually is a mesh structure formed from a braided organic yarn, such as polyester fiber, rayon fiber, or nylon fiber. The braiding fibers are typically comprised of a polyester, such as polyethylene terphthalate (PET) or polyethylene naphthalate (PEN). The polyester can also be a copolyester having an acid component which is comprised of terephthalic acid and isophthalic acid with its diol component being comprised of ethylene glycol. Such copolyesters with typically have an acid component which includes about 96% to about 99% terephthalic acid and about 1% to about 4% isophthalic acid. It is more typical for such copolyesters to have an acid component which includes about 96% to about 99% terephthalic acid and about 1% to about 2% isophthalic acid.

An outer layer of elastomer resistant to ozone, engine oil and other contaminating materials commonly present in vehicle engine compartments is typically extruded over the braided reinforcement. Generally, the inner and outer layers of the tube are formed of rubber, including butyl rubbers, ethylene propylene diene rubber (EPDM), chloroprene rubber (CR), nitrile rubbers (NBR), hydrogenated nitrile rubbers (HNBR), or ethylene acrylic copolymer rubber. The inner layer of barrier hose is typically comprised of CR or butyl rubber. The outer layer is typically comprised of neoprene or butyl rubber. The outer cover typically is formed of EPDM, CR, butyl rubbers, or ethylene acrylic copolymer rubber. Adhesion layers are typically employed between the barrier and reinforcing layers of the hose.

The hoses used for transporting refrigerants generally have a high degree of flexibility which facilitates handling them and implementing their use in cooling devices. However, rubbery materials that provide the needed degree of flexibility generally tend to have high gas permeability. Attempts to improve the resistance of conventional rubber hoses to refrigerant permeation have been made by incorporating polyamide layers, such as nylon 6, nylon 66, modified nylon 6, or alloys of nylon 6, and the like, as an inner layer. However, the use of such polyamide layers, while reducing permeation rates, also reduces the flexibility of the hoses. To achieve an acceptable compromise of the required characteristics, the thickness of a nylon inner core layer is conventionally at least 0.1 mm (0.004 inch). U.S. Pat. No. 4,633,912 discloses such a hose having a polyamide blend as the core tube.

Hoses may be characterized as barrier or veneer hose, the distinction between the two being the type of material forming the innermost layer. Barrier hoses have the innermost layer formed of an elastomeric material and a barrier layer located outward of the innermost layer. In hoses where the barrier layer is the innermost layer, the hose is referred to a veneer hose. Some applications may use either type of hose, such as fuel hose, while other applications may require a specific internal material and thus only one type of hose would be appropriate.

U.S. Pat. No. 4,633,912 discloses a composite hose for freon gas, comprising a polyamide core tube, an elastic friction layer having the specific composition and being directly provided on a core tube, a first reinforcement strand layer, an adhesive barrier friction layer, a second reinforcement strand layer, and then a cover layer. The elastic friction layer which is positioned directly on the core tube comprises (a) a base rubber selected from EPDM, a copolymer of butadiene, polychloroprene, polybutadiene, polyisoprene or a mixture thereof, (b) a calcium ion source, (c) resorcinol or a phenol-based adhesive system, and (d) a peroxide or a sulfuric vulcanizing agent. The calcium source (b) is said to make better adhesion to a polyamide of the core tube. The adhesive barrier friction layer being present between the first and second reinforcement strand layers is provided to minimize a friction of the strands, and is made of a copolymer of ethylene and acrylic acid. For the cover layer, a halogenated butyl rubber containing bis-dienophile as a crosslinking agent is used.

U.S. Pat. No. 5,488,974 discloses a composite hose for automotive air conditioning systems. This hose consists of the innermost layer, the intermediate rubber layer, a fibrous reinforcement layer and an external rubber layer, each of which is formed in this order from the inside. The innermost layer is formed of a modified polyamide obtainable by blending of a polyamide and a carboxyl-containing modified polyolefin, and the intermediate rubber layer is formed of a rubber composition obtainable by a blend of 10 to 50 parts by weight of silicic acid or a salt thereof and 5 to 15 parts by weight of a brominated alkylphenol formaldehyde resin per 100 parts of the rubber material obtainable by blending butyl rubber and a halogenated butyl rubber at a weight ratio of 50/50 to 0/100.

U.S. Pat. No. 6,376,036 relates to a composite flexible hose, preferably for use in automotive air conditioning systems, with improved thermal resistance. The hose consists of an innermost core layer, a friction rubber layer, an intermediate reinforcement layer, and an external cover layer. The innermost layer is a non-plasticized polyamide mixed with a minor portion of polyolefin corresponding to the main rubber constituent of the friction coat layer. The friction coating is formed of a rubber composite of two EPDM rubbers at a weight ratio of 50/50 and 75 parts by weight of carbon black. The intermediate fibrous reinforcement layer is formed of aramid. The external layer is an acrylate rubber comprising a blend of two ethylene acrylates at a weight ratio of 50/50 and 80 parts by weight of carbon black.

U.S. Pat. No. 6,941,975 discloses a hose suitable for use in refrigerant systems. This hose has a barrier layer formed of at least two layers of thermoplastic resin. At least one of the layers is a vinyl resin. The resins are selected so that the hose has a permeation rate of virtually zero. U.S. Pat. No. 6,941,975 more specifically discloses a hose comprising an inner barrier layer, a radially outer intermediate layer bonded directly to the inner barrier layer, a reinforcing layer, and a cover layer, wherein the barrier layer is formed of at least two resin layers and wherein the two resin layers are formed of two different materials and at least one of the resin layers is a vinyl resin.

### SUMMARY OF THE INVENTION

The air conditioning hose of this invention offers an extremely high level of resistance to permeation by refrigerants, including carbon dioxide, as well as good flexibility, high strength, the ability to bend to small radii without kinking, and the ability to be tightly coupled to refrigeration device components in a leak proof fashion. These objectives are accomplished in the practice of this invention by incorporating a layer of a metal foil into the air conditioning hose structure. The layer of metal foil acts to inhibit permeation by refrigerants, including carbon dioxide, to keep the refrigerant for escaping through the hose and into the atmosphere.

One traditional problem with the incorporation of layers of metal foils into hose structures is poor adhesion between the layer of metal foil and surrounding polymeric layers. This problem is overcome in the practice of this invention by positioning the layer of metal foil immediately above and in contact with a core layer of the hose wherein the core layer is comprised of a thermoplastic polymer and wherein the core layer is perforated. The perforations in the core layer allow refrigerant which permeates through the core layer to flow back into the lumen of the hose thereby preventing the refrigerant which is trapped between the core layer and the metal foil from dislodging the core layer from the layer of metal foil.

The subject invention more specifically discloses a refrigerant hose comprising: (a) a core layer, wherein the core layer is comprised of a thermoplastic polymer, and wherein the core layer is perforated; (b) a metal foil layer which is situated over the core layer; (c) plastic layer which is situated over the metal foil layer; (d) a rubber layer which is situated over the plastic layer, (e) a reinforcing layer which is situated over the rubber layer; and (f) a cover layer which is situated over the reinforcing layer, wherein the cover layer is comprised of a rubbery polymer.

### BRIEF DESCRIPTION OF THE DRAWINGS

FIG. 1 is a cut-away view of a refrigerant hose of this invention which illustrates the various layers therein.

### DETAILED DESCRIPTION OF THE INVENTION

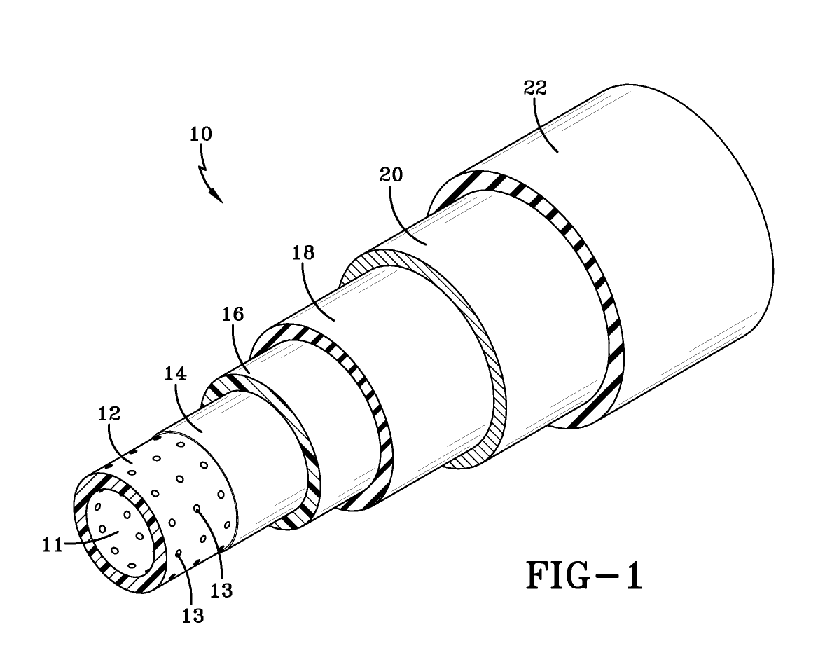

The refrigerant hose 10 of the present invention is illustrated in FIG. 1 and typically has an inside diameter of about 2 mm to 10 mm. The refrigerant hose of this invention will more typically have an inside diameter of 4 mm to 8 mm and will frequently have a diameter of 5 mm to 7 mm. The hose 10 has a core layer 12, relative to the radial direction of the hose and the longitudinal hose axis. The core layer 12 is formed from a plastic material which is typically an ethylene vinyl alcohol (EVOH), a polyamide (nylon), or a polyolefin, such as polyethylene (PE) or polypropylene (PP) and is the innermost layer of the hose. This tubular inner core layer defines the lumen 11 of the hose and is typically about 0.01 inch (0.25 mm) to 0.1 inch (2.5 mm) thick. In most cases the core layer is 0.02 inch (0.51 mm) to 0.08 inch (2.03 mm) thick with it commonly being 0.03 inch (0.76 mm) to 0.05 inch (1.27 mm) thick. The tubular inner core layer 12 is frequently referred to in the art as simply the “tube” or as simply as the “core.”

The core layer 12 is perforated with a multitude of perforations 13 which extend completely through the core layer 12. These perforations (holes) can be of a wide variety of geometric configurations. For instance, the perforations 13 can be circular, square shaped, triangle shaped, pentagon shaped, octagon shaped, star shaped, ovals, or rectangular. However, in most cases the perforations 13 will be essentially circular in shape and can be pricked, pierced, drilled, or punched into the core layer 12. The perforations 13 which are essentially circular in shape will typically have a diameter of less than 0.01 inch (0.25 mm). Such perforations 13 will typically have a diameter of about 0.001 inch (0.025 mm) to about 0.01 inch (0.25 mm) and will more typically have a diameter of 0.002 inch (0.051 mm) to about 0.08 inch (0.20 mm). The perforations 13 normally be distributed relatively evenly over the surface of the core layer 12 and will preferably be evenly distributed over the surface of the core layer 12. Typically, 0.1 to 10 holes/in² (155 to 15,500 holes/m²) will be distributed over the outside surface of the core layer 12. The core layer 12 will more typically contain from 0.25 to 4 holes/in² (387 to 6,200 holes/m²) on its outside surface and will commonly have 0.5 to 2 holes/in² (775 to 3100 holes/m²) of its outside surface. For instance, the core layer 12 can have 1 to 1.5 holes/in² (1550 to 2325 holes/m²) of its outside surface.

Over the core layer 12 and in immediate contact with the core layer 12 is a metal foil layer 14 which acts as a permeation inhibiting layer. In other words, the metal foil layer 14 is positional immediately outwardly from the core layer 12 of the hose 10. The metal foil layer 14 is typically less than about 0.005 inch (0.127 mm) thick. In most cases, the metal foil layer 14 has a thickness which is within the range of 0.001 inch (0.0254 mm) to 0.005 (0.127 mm) inch. The metal foil layer 14 will more typically have a thickness which is within the range of 0.002 inch (0.0508 mm) to 0.004 inch (0.1016 mm). The metal foil layer 14 can be comprised of a wide variety of metals and will typically be comprised of a metal which is relatively malleable and which has good gas barrier properties, such as aluminum, copper, tin, brass, or gold. It is normally preferred to utilize aluminum foil as the metal foil layer 14.

A plastic layer 16 is positional outwardly from the metal foil layer 14. This additional plastic layer 16 is normally positional immediately outwardly from the metal foil layer 14 and in normally in direct contact with the metal foil layer 14. The plastic layer 16 is typically comprised of an ethylene vinyl alcohol (EVOH), a polyamide (nylon), or a polyolefin, such as polyethylene (PE) or polypropylene (PP).

The rubber layer 18 is situated over and outwardly from the plastic layer 16 in the hose 10 of this invention. The rubber layer 18 will typically be in direct contact with the plastic layer 16. This rubber layer 18 (the tie layer) will typically be comprised a butyl rubber, a nitrile rubber, an ethylene-propylene-diene rubber (EPDM), an ethylene-propylene rubber (EPR), an ethylene acrylic elastomer, natural rubber, styrene-butadiene rubber (SBR), or the like. The rubber layer 18 will typically be from 0.02 inch (0.508 mm) to 0.05 inch (1.27 mm) thick. The rubber layer 18 is also known in the art as a friction layer and the terms “rubber layer” and “friction layer” can be used interchangeably for purposes of the present invention.

The air conditioner hoses of this invention have a reinforcing layer 20 which is situated over and outwardly from the rubber layer 18. The reinforcing layer 20 will typically be in direct contact with the rubber layer 18. The reinforcing layer 20 may be formed by braiding, spiraling, knitting, or helical knitting of yarn or metal cords. The yarn may be selected from natural or synthetic textile yarn or metallic wire reinforcements which are conventionally utilized in reinforcing high temperature/high pressure hoses, such as glass, polyester, polyamide (nylon) or aramid fibers, or a blend of any such of these fibers. In some cases it is advantageous for the reinforcing layer 20 to be comprised of a steel reinforcing element. The reinforcing layer 20 will typically be comprised of nylon or aramid fibers with aramid fibers generally being preferred.

The refrigerant hoses of this invention have a cover layer 22 which is situated over and outwardly from the reinforcing layer 20. The cover layer 22 will typically be in direct contact with the reinforcing layer 20. The cover layer 22 will typically be comprised of a rubbery polymer. Some representative examples of rubbery polymers that can be used in the cover layer 22 include a butyl rubber, a nitrile rubber, an ethylene-propylene-diene rubber (EPDM), an ethylene-propylene rubber (EPR), an ethylene acrylic elastomer, natural rubber, styrene-butadiene rubber (SBR), or the like. The cover layer 22 employed in the practice of this invention is frequently comprised of an EPDM rubber and is typically from 0.02 inch (0.51 mm) to 0.08 inch (2.03 mm) thick and which is commonly 0.03 inch (0.76 mm) to 0.06 inch (1.52 mm) thick.

The hose 10 of this invention typically has a permeation rate of not greater than 0.001 g/cm/day of carbon dioxide refrigerant and preferably has a permeation rate of not greater than 0.0003 g/cm/day of carbon dioxide refrigerant. A permeation rate this low is generally considered to be a zero permeation rate.

The rubber components utilized in the hose of this invention can be cured with conventional sulfur or peroxide curatives depending upon the elastomer being employed. For example, peroxides, such as dicumyl peroxide, .α-α-bis(t-butylperoxide)diisopropylbenzene, benzoyl peroxide, 2,4-dichlorobenzoyl peroxide, 1,1-bis(t-butylperoxy)3,3,5-trimethylcyclohexane, 2,5-dimethyl-2,5-bis(t-butylperoxy)hexane, 2,5-dimethyl-2,5-bis(t-butylperoxy)hexyne-3, and n-butyl 4,4-bis(t-butylperoxy)valerate can be employer in curing the rubber components of the hose. The most preferred and commercially available peroxide curatives are Percadox™ 14/40 from Noury Chemical Corporation and Vul-Cup™ from Penwalt Corporation. From 1 to about 10 parts of peroxide are generally utilized based on 100 parts of base polymer. Peroxides are preferred as the curative since they are less sensitive to premature crosslinking (scorch). The rubbery components employed in the hose of this invention can also contain various additives in conventional or suitable amounts known to persons having ordinary skill in the art. Such additives may include, and are not limited to retardants to prevent an unduly quick cure, antioxidants, processing aids, reinforcing agents and fillers, such as carbon black, silica, and the like. The adhesive systems useful in adhering the various component layers to other component layers in accordance with this invention are the conventionally known adhesive. For example, maleinized 1,2-polybutadiene resin and various plasticizers can be employed in manufacturing the air conditioning hoses of this invention.

While certain representative embodiments and details have been shown for the purpose of illustrating the subject invention, it will be apparent to those skilled in this art that various changes and modifications can be made therein without departing from the scope of the subject invention.

What is claimed is:

1. A refrigerant hose comprising: (a) a core layer, wherein the core layer is comprised of a thermoplastic polymer, and wherein the core layer includes perforations (b) a metal foil layer which is situated over the core layer; (c) plastic layer which is situated over the metal foil layer; (d) a rubber layer which is situated over the plastic layer, (e) a reinforcing layer which is situated over the rubber layer; and (f) a cover layer which is situated over the reinforcing layer, wherein the cover layer is comprised of a rubbery polymer.

2. The refrigerant hose as specified in claim 1 wherein the reinforcing layer is a woven fabric which is comprised of glass fibers, polyester fibers, or aramid fibers

3. The refrigerant hose as specified in claim 1 wherein the reinforcing layer is comprised of steel wires.

4. The refrigerant hose as specified in claim 1 wherein the cover layer is comprised of ethylene-propylene-diene monomer rubber.

5. The refrigerant hose as specified in claim 1 wherein the reinforcement layer is a woven aramid fabric.

6. The refrigerant hose as specified in claim 1 wherein the reinforcement layer is a woven nylon fabric.

7. The refrigerant hose as specified in claim 6 wherein the nylon fabric is woven in a 1-over/1-under pattern.

8. The refrigerant hose as specified in claim 1 wherein the cover layer includes pin-pricks.

9. A hose in accordance with claim 1 wherein the hose has a permeation rate of not greater than 0.0020 g/cm/day of carbon dioxide refrigerant.

10. The refrigerant hose as specified in claim 1 wherein the core layer has a thickness which is within the range of 0.02 inch to 0.08 inch.

11. The refrigerant hose as specified in claim 1 wherein the perforations in the core layer are essentially circular and have a diameter which is within the range of about 0.001 inch to about 0.01 inch.

12. The refrigerant hose as specified in claim 1 wherein the perforations in the core layer are essentially circular and have a diameter which is within the range of 0.002 inch to about 0.08 inch.

13. The refrigerant hose as specified in claim 12 wherein the perforations in the core layer are distributed essentially evenly over the surface of the core layer with 0.1 to 10 perforations be distributed per square inch over the outside surface of the core layer.

14. The refrigerant hose as specified in claim 12 wherein the perforations in the core layer are distributed essentially evenly over the surface of the core layer with 0.25 to 4 perforations be distributed per square inch over the outside surface of the core layer.

15. The refrigerant hose as specified in claim 12 wherein the perforations in the core layer are distributed essentially evenly over the surface of the core layer with 0.5 to 2 perforations be distributed per square inch over the outside surface of the core layer.

16. The refrigerant hose as specified in claim 12 wherein the perforations in the core layer are distributed essentially evenly over the surface of the core layer with 1 to 1.5 perforations be distributed per square inch over the outside surface of the core layer.

17. The refrigerant hose as specified in claim 1 wherein the metal foil is a brass foil or a copper foil.

18. The refrigerant hose as specified in claim 1 wherein the metal foil is an aluminum foil.

19. The refrigerant hose as specified in claim 1 wherein the cover layer has a thickness which is within the range of 0.02 inch to 0.08 inch.

20. The refrigerant hose as specified in claim 1 wherein the rubber layer is comprised of ethylene acrylic elastomer.
